(19) United States
(12) Patent Application Publication
(10) Pub. No.: US 2020/0269402 A1
(43) Pub. Date: Aug. 27, 2020

(54) PYROTECHNIC DRIVING TOOL

(71) Applicant: Hilti Aktiengesellschaft, Schaan (LI)

(72) Inventor: Harald FIELITZ, Lindau (DE)

(21) Appl. No.: 16/063,790

(22) PCT Filed: Dec. 21, 2016
(86) PCT No.: PCT/EP2016/082056

§ 371 Date: Jun. 19, 2018

(30) Foreign Application Priority Data
Dec. 23, 2015 (EP) 15202290.1

(51) Int. Cl. B25C 1/00; B25C 1/14

(52) U.S. Cl. CPC B25C 1/008; B25C 1/143

(57) ABSTRACT

A driving tool, comprising a handheld housing with a piston accommodated therein for transmitting energy to a fastening element to be driven in, a propellant charge for generating a gas pressure, a placing member that is able to be pressed against a workpiece, an in particular movable breech face for absorbing a recoil, and an ignition hammer that is movable relative to the breech face, wherein the ignition hammer is accelerated by means of at least one first spring against an igniter of the propellant charge, and wherein the spring is held in a tensioned state by a controllable holding member before the ignition hammer is accelerated, wherein the first spring is moved back into the held and tensioned state by the gas pressure after an ignition operation.

The invention relates to a driving tool, in particular a hand-held driving tool according to the preamble of claim 1.

In general, the invention relates to driving tools in which a driving piston is accelerated by a rapidly expanding gas resulting from the combustion of a propellant charge. Common constructions of such devices use powder cartridges, caseless propellant charges in the form of charge strips, or the like for this purpose.

In such devices, an firing hammer in the form of a pin is usually tensioned when a contact element of the device is pressed against a workpiece. A corresponding stroke of the contact element closes a cartridge chamber of the device and tensions the firing hammer against a spring.

DE 102 53 668 B4 describes a pyrotechnic driving tool in which an ignition unit is moved by the gas pressure during a driving process into a partially-tensioned position against a spring, and held by a detent. The ignition unit is then fully tensioned—as in the device DX 460—when a contact element is pushed. The partial tensioning of the ignition unit by means of the gas pressure is realized structurally by the ignition unit being designed integrally with, or being functionally identical to, an impact base of the device. The relatively high mass of the impact base/ignition unit initially strikes—accelerated by a spring—the propellant charge, ignites it, then serves as a counter bearing for the gas pressure, accelerated back against the spring.

The problem addressed by the invention is that of providing a driving tool which enables a low pressing force of the contact element.

This problem is addressed according to the invention for a driving tool as named at the outset, having the characterizing features of claim 1. By bringing the spring into the tensioned and retained state by means of the gas pressure, a configuration is achieved in which the contact element need not be moved against the force of the first spring.

A contact element in the context of the invention means a component which is placed with a front end on the workpiece and pushed-in by a defined stroke to enable a setting operation. Such a contact element serves as a reliable safety device in the operation of the driving tool. The contact element may be designed, by way of example, as a sleeve arranged concentrically to a central axis of the device. Alternatively, it may be a contact part arranged laterally-offset from the central axis, for example. Preferably, a cartridge chamber of the propellant charge is only closed upon the depression of the contact element, such that a misfire of a propellant charge without the contact element depressed cannot lead to a significant acceleration of the piston element.

For ergonomic reasons, a short stroke of the contact element is desired; however, this is associated with higher pressing forces for actuating the mechanism connected to the contact element. The required pressing forces can be advantageously reduced according to the invention if the first spring, used to accelerate the firing hammer, need not generally be tensioned by the movement of the contact element.

For the purposes of the invention, a firing hammer is understood to mean any element which is held in a manner allowing movement relative to the propellant charge and which is accelerated and moved against an igniter of the propellant charge to trigger the propellant charge. The firing hammer may preferably be formed as a linearly movable pin. An igniter in the sense of the invention may be, for example, an impact-sensitive charge in a firing plate, a firing edge in a rimfire cartridge, an impact-sensitive firing zone of a charge strip, or the like.

In the sense of the invention, an impact base is understood to mean a component which supports the forces from behind during the acceleration of the piston, and thus initially absorbs a portion of a recoil of the device. Preferably, the impact base in this case is held in a manner allowing movement relative to a housing of the device, such that the maximum forces affecting an operator can be reduced.

A controllable retaining element of the first spring means, in the context of the invention, any device by means of which the tensioned spring can be held, and can be released if necessary by the operator. The release of the tensioned spring results in the acceleration of the firing hammer.

In the context of the invention, the first spring may be any suitable mechanical energy storage device—for example, a metal spiral spring or a gas spring.

In a generally preferred embodiment, the impact base is moved counter to the driving direction by the gas pressure, and thereby tensions the first spring. This enables a simple and reliable mechanical realization of a tensioning of the first spring by the gas pressure.

Further advantageously, a force can be applied to the impact base in the driving direction by means of an impact base spring. This enables a particularly gentle transmission of recoil forces to an operator. The impact base spring usually has a larger spring constant than the first spring.

In a simple realization of a driving tool according to the invention, the retaining element comprises a spring-loaded locking catch. When the firing hammer and/or a component which bears the first spring travels past the locking catch, the locking catch locks and holds the first spring in the tensioned state.

In a generally advantageous manner, the first spring is alternatively moved to the retained and tensioned state by the pressing of the contact element. This enables a simple construction and intuitive operation. In general, only one first tensioning operation of the spring is performed by the pressing of the contact element to allow the first ignition of a propellant charge. In the subsequent setting operations, the first spring has already been tensioned each time by the gas pressure of the preceding setting operation, thereby achieving reduced pressing forces of the contact element for this purpose. Finally, the tension of the first spring can be released—for example, for the purpose of storage or maintenance of the device. In alternative embodiments of the invention, however, an additional tensioning lever or the like can be included for tensioning the first spring before a first setting operation.

In a particularly preferred embodiment, force is applied to the firing hammer in the direction of the igniter by means of a second spring. Preferably, the second spring has a smaller spring constant than the first spring. The firing hammer can initially be held in a forward position by the second spring, even if the first spring is tensioned, thereby achieving high operational reliability, preventing a false triggering of a propellant charge—for example, due to the device being dropped, or the like. Particularly preferably, the second spring is moved into a tensioned state exclusively by the pressing of the contact element. Since the force of the second spring is not required for the acceleration of the firing hammer, it can be small enough so that its resistance when the device is pressed is negligible.

In a generally advantageous manner, the movement of the firing hammer between an untensioned stop of the first spring and a contact with the igniter comprises a free travel path. The firing hammer thus moves in its last movement section only as a result of its inertia, rather than under the force of the first spring. In particular, this allows the provision of effective security measures to prevent unintentional triggering of the propellant charge. For example, the propellant charge cannot be triggered in such an arrangement if the firing hammer is already at rest in a forward position upon a faulty release of the first spring.

Further advantages and features of the invention will become apparent from the embodiments described below, and from the dependent claims.

Two embodiments of the invention are described and explained below in more detail with reference to the accompanying drawings.

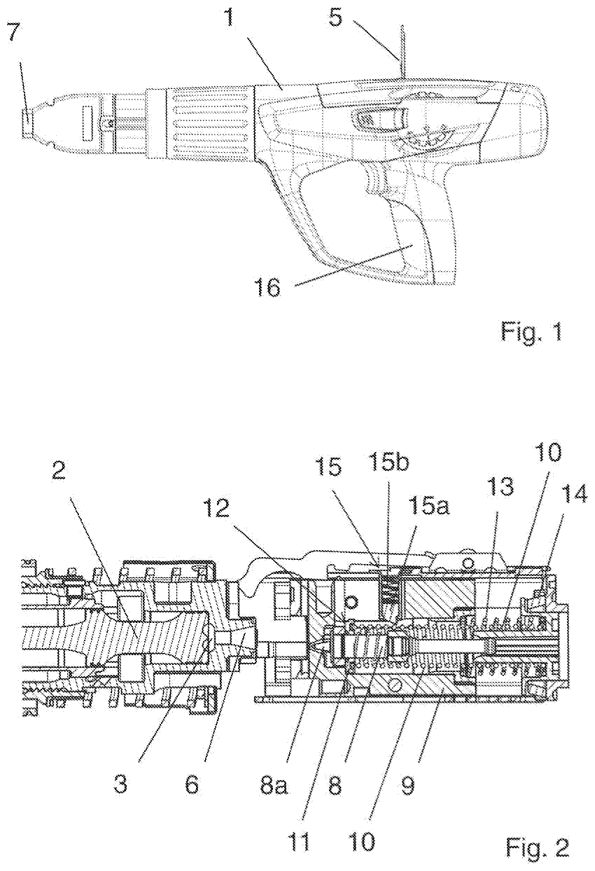

FIG. 1 shows a schematic overall view of a driving tool according to the invention.

FIG. 2 shows a partial sectional view of a first embodiment of the invention in an untensioned state.

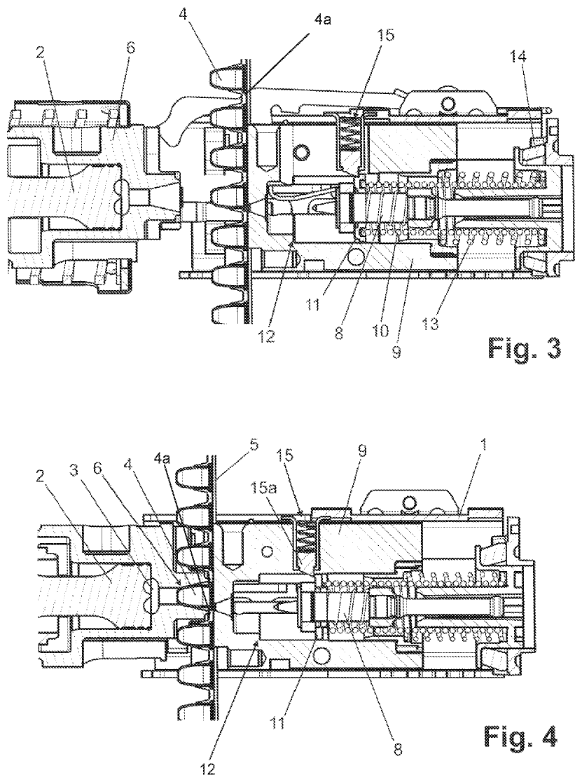

FIG. 3 shows the embodiment of FIG. 2 in a tensioned state with no workpiece contact.

FIG. 4 shows the embodiment of FIG. 2 in a tensioned state with workpiece contact.

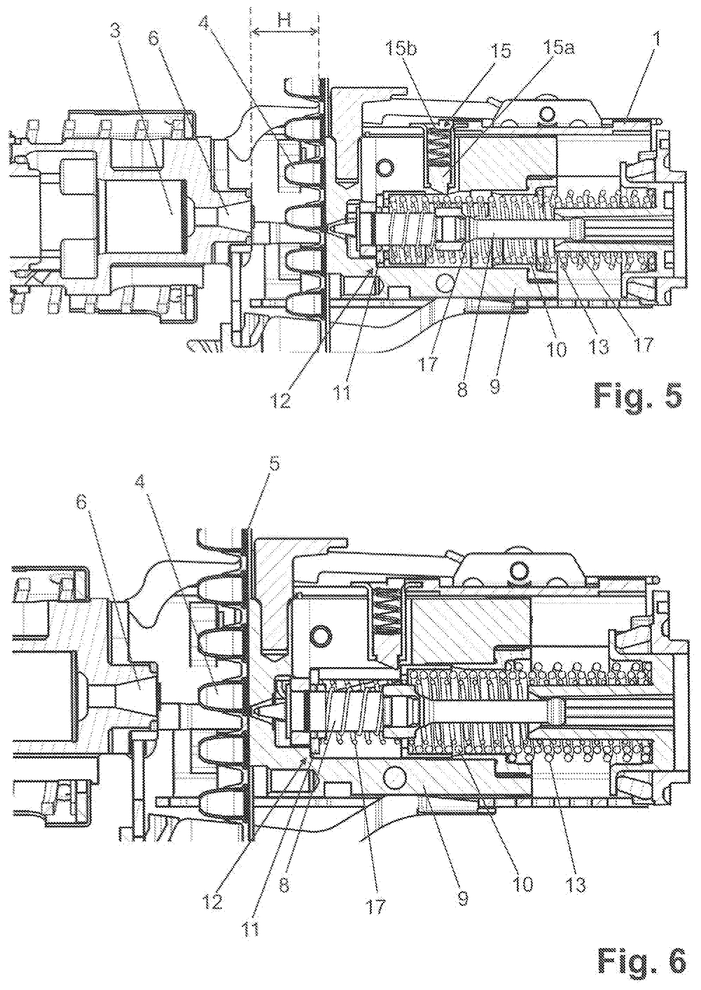

FIG. 5 shows a partial sectional view of a second embodiment of the invention in an untensioned state.

FIG. 6 shows the embodiment of FIG. 5 in a tensioned state with no workpiece contact.

A driving tool according to the invention comprises a hand-held housing 1 in which a piston element in the form of a piston 2 is accommodated. A rear surface of the piston 2 defines a combustion chamber 3 in which the combustion gases of a pyrotechnic propellant charge 4 expand to accelerate the piston 2.

The piston 2 provided with kinetic energy in this manner strikes, with a ram on the end-face thereof, a fastener element (not shown), which is thereby driven into a workpiece.

The propellant charge 4 in this case is accommodated on a charge strip 5 with a plurality of cartridge-shaped charges (FIG. 3). The propellant charge 4 has an impact-sensitive igniter 4a in an edge region. Prior to ignition, a charge chamber 6 which adjoins the combustion chamber 3 is driven against the propellant charge 4 via a corresponding mechanism (see ignition-ready state in FIG. 4).

A contact element 7 which can slide relative to the housing 1 is arranged on the front end of the device and connected to the charge chamber 6. The contact element 7 is placed on the workpiece in the course of a driving operation and pushed-in a defined stroke H distance (see FIG. 5) against a spring force. As a result, inter alia, the charge chamber 6 is pushed back against the propellant charge 4.

The ignition occurs due to the impact of a firing hammer 8 accelerated against the igniter 4a of a propellant charge 4. In the present case, the firing hammer 8 is substantially formed as a pin which is mounted to allow movement parallel to a driving direction.

The firing hammer 8 is arranged in a central recess of an impact base 9 which is likewise movable parallel to the driving direction, wherein the firing hammer 8 is also movable relative to the impact base 9. A tip 8a of the firing hammer 8 can pass through a front opening of the impact base 9 and strike the igniter 4a.

The firing hammer 8 is supported with respect to the housing 1 by means of a first spring 10, and subjected to a force in the direction of the propellant charge 4. The first spring 10 is mounted on the front side in a sleeve 11, wherein the sleeve 11 is slidably guided on the impact base 9. A front stop 12 of the sleeve 11 on the impact base 9 defines a maximum untensioned position of the first spring 10. The stop 12 is positioned in such a manner that the firing hammer 8 still has a free travel path of about 2 mm until contact with the igniter 4a when the sleeve 11 comes to rest against the stop 12.

The impact base 9, in turn, is supported by an impact base spring 13 with respect to the housing 1. The first spring 10 is expediently arranged, from a structural point of view, concentrically within the impact base spring 13. A damper 14 made of elastic material is attached to a rear stop of the impact base 9.

The first spring 10 can be held in a tensioned position by means of a schematically-illustrated retaining element 15. The retaining element in the present case is designed as a spring retainer, wherein a detent 15a which can be moved perpendicular to the driving direction is subjected to force by means of a detent spring 15b. When the sleeve 11 of the spring 10 travels over a ramp of the detent 15a in the course of a tensioning movement, the detent 15a snaps over the edge of the sleeve 11 and holds the first spring 10 in the tensioned state.

The first spring 10 is released when the catch 15a is lifted. This can be done by a corresponding mechanism (not shown) by operating a trigger 16 of the driving tool, by an electromechanical actuator, or in another manner.

The invention works as follows:

Starting from an untensioned state of the first spring 10 (see FIG. 2), a first tensioning of the first spring 10 must be performed initially. In the present case, this is achieved by pressing-in the contact element 7 the distance of the stroke H. Accordingly, an increased force must be applied by the operator for the first setting operation and/or for the first spring tensioning.

FIG. 3 shows a position of the driving tool with tensioned first spring 10 and no contact with the workpiece. In the case of the first embodiment, with the first spring 10 tensioned, the firing hammer 8 is also held in a rear position together with the spring 10. The device is usually in this state during its use and between the setting operation.

To trigger a setting operation, the device is pressed against a workpiece and the contact element 7 is pushed in the distance of the stroke H, such that the propellant charge 4 and charge chamber 6 are brought together. This condition is shown in FIG. 4.

If the trigger 16 is then actuated, the retaining element 15 releases the first spring 10. This accelerates the firing hammer 8 forward in the direction of the igniter 4a, until the sleeve 11 reaches the stop 12 on the impact base 9. The firing hammer 8 then travels the last free distance without further acceleration and strikes the igniter 4a. A reliable ignition occurs according to the appropriate design of mass and speed of the firing hammer 8.

During the expansion of the combustion gases, the piston 2 is accelerated forward and the impact base 9 supporting the gas pressure is moved back against the impact base spring 13. The impact base 9 in this case carries the sleeve 11 with it, and tensions the first spring 10. By passing over the spring-loaded detent 15a, the first spring is returned to a tensioned and retained state without the operator needing to expend any force before the subsequent setting operation.

Depending on requirements, the first spring can be untensioned after completion of the work, for storage of the device—for example, by firing a blank shot without a propellant charge.

In a second embodiment according to FIGS. 5 and 6, additional measures are taken to prevent an unintended activation of the propellant charge. For this purpose, a further, second spring 17 is configured on the firing hammer 8, which presses the firing hammer 8 forward, like the first spring 10. This ensures that the firing hammer is permanently held in its forward position even when the first spring is tensioned when the device is not in contact with a workpiece. Because the stop 12 is reached before the igniter 8 is struck, an unintentional release of the first spring would therefore not lead to an acceleration of the firing hammer or any other effect on the propellant charge 4.

FIG. 5 shows the second embodiment with the first spring 10 untensioned, and with no contact with a workpiece. FIG. 6 shows the state with no workpiece contact, when the first spring 10 is tensioned—that is, the typical state of use between two setting operations.

The second spring 17 is arranged concentrically within the first spring 10, and has a significantly smaller spring constant. As a result, it represents a negligible resistance to the operator when the device is pressed against a workpiece. The contribution of the second spring 12 to the acceleration of the firing hammer 8 is accordingly negligible, such that the second spring 17 only serves to position the firing hammer for safety reasons.

When the driving tool is pressed against a workpiece, the firing hammer is pushed backward against the second spring 17 via a mechanism (not shown) connected to the contact element. This state is not shown, but corresponds to the state of FIG. 4 with respect to the position of the components.

When the setting operation is initiated, the retaining element 15 releases the first spring 10, as in the first example. Via a mechanism which is not shown, the second spring 17 is released at the same time, such that the firing hammer 8 is accelerated forward by the springs 10, 17. As in the first example, the acceleration effected by the first spring 10 and the second spring 17 ends at the stop 12. The igniter is not subjected to acceleration over the subsequent free travel path of approx. 2 mm. Rather, it continues its movement only due to its inertia.

1. A driving tool, comprising
a handheld housing with a piston accommodated therein, for transmitting energy to a fastener being driven-in in a driving direction;
a propellant charge for generating gas pressure; pressure
a contact element which can be pressed against a workpiece;
a movable impact base for supporting a recoil; and
a firing hammer which can be moved relative to the impact base,
wherein the firing hammer is accelerated by at least one first spring against an igniter of the propellant charge,
wherein the at least one first spring is retained in a tensioned state by a controllable retaining element before the acceleration of the firing hammer; and
wherein the first spring is returned by the gas pressure to the retained and tensioned state after an ignition procedure.

2. The driving tool according to claim 1, wherein the impact base is moved counter to the driving direction by the gas pressure, and tensions the at least one first spring as a result.

3. The driving tool according to claim 1, wherein the tool has an impact base spring and force is applied to the impact base in the driving direction by the impact base spring.

4. The driving tool according to claim 1, wherein the retaining element comprises a spring-loaded locking catch.

5. The driving tool according to claim 1, wherein the at least one first spring is alternatively brought into the retained and tensioned state by the contact element being pressed.

6. The driving tool according to claim 1, wherein force is applied to the firing hammer in a direction of the igniter by a second spring.

7. The driving tool according to claim 6, wherein the second spring is moved into a tensioned state exclusively by the pressing of the contact element.

8. The driving tool according to claim 1, wherein movement of the firing hammer between an untensioned stop of the at least one first spring and a contact with the igniter comprises a free travel path.

9. The driving tool according to claim 6, wherein the second spring has a smaller spring constant than the at least one first spring.

10. The driving tool according to claim 2, wherein the tool has an impact base spring and force is applied to the impact base in the driving direction by the impact base spring.

11. The driving tool according to claim 2, wherein the retaining element comprises a spring-loaded locking catch.

12. The driving tool according to claim 3, wherein the retaining element comprises a spring-loaded locking catch.

13. The driving tool according to claim 2, wherein the at least one first spring is alternatively brought into the retained and tensioned state by the contact element being pressed.

14. The driving tool according to claim 3, wherein the at least one first spring is alternatively brought into the retained and tensioned state by the contact element being pressed.

15. The driving tool according to claim 4, wherein the at least one first spring is alternatively brought into the retained and tensioned state by the contact element being pressed.

16. The driving tool according to claim 2, wherein force is applied to the firing hammer in a direction of the igniter by a second spring.

17. The driving tool according to claim 3, wherein force is applied to the firing hammer in a direction of the igniter by a second spring.

18. The driving tool according to claim 4, wherein force is applied to the firing hammer in a direction of the igniter by a second spring.

19. The driving tool according to claim 5, wherein force is applied to the firing hammer in a direction of the igniter by a second spring.

20. The driving tool according to claim 6, wherein the second spring is moved into a tensioned state exclusively by the pressing of the contact element.
